(19) United States
(12) Patent Application Publication
(10) Pub. No.: US 2008/0107895 A1
(43) Pub. Date: May 8, 2008

(54) Offset PS Plate with Compound Support and Its Manufacturing Process

(75) Inventor: Xiangfeng CHEN, Zhejiang Province (CN)

Correspondence Address: ERIC CHAN, 42 PIN OAKS DRIVE, PHOENIXVILLE, PA, 19460, US

(73) Assignee: WENZHOU KONITA PRINTING EQUIPMENT CO., LTD.

(21) Appl. No.: 11/936,796

(22) Filed: Nov. 8, 2007

(30) Foreign Application Priority Data
Nov. 8, 2006 (CN) 200610154602.8

(51) Int. Cl. B32B 15/08

(52) U.S. Cl. 428/336; 428/461

(57) ABSTRACT

This invention involves with a kind of offset PS plate with compound support and its manufacturing process. PS plate has sensitization imaging layer set up on the front side of its aluminum substrate, and has a membrane of polymer materials covered on the back side of the substrate, which form the structure of compound support. The manufacturing process firstly deoils and cleans the aluminum substrate, and covers a membrane of polymer materials on the back side of plate substrate; then conducts electrochemical corrosion and roughening, generates oxidation layer through the oxidization of anode, carries out sealing or hydrophilic treatment for the oxidation layer, and coats sensitization liquid onto this oxidation layer; finally, dries and cuts the plates into finished products. This invention may use relatively thin aluminum materials to keep relatively high quality, greatly reduce the consumption of aluminum, and decrease the cost. The mentioned membrane is featured by strong toughness; after compounding, the substrate enjoys great tensile strength, so the plate is not easy to break during printing; and also, the substrate has lower density, which could lighten the weight of finished plates. Polymer membranes have extremely smooth surface, so multiple sheets of PS plates overlapped won't scratch the sensitization layer, and will require no interleaving paper. What's more, the manufacturing process of PS plate with compound support is basically accordant with the original one, and the compounding of membrane is simple and quick.

### BACKGROUND OF THE INVENTION

This invention involves with a kind of presensitized plate (PS plate) or Computer-to-Plate plate (CTP plate) in printing industry, as well as the manufacturing process of plates.

Common PS plate or CTP plate adopts aluminum support substrate, and has sensitization imaging layer set up on the front side of the substrate. In manufacturing, the surface of aluminum substrate is roughened, anodized, and conducted sealing or hydrophilic treatment to keep the adsorption of the oxidization layer; and with sensitization imaging layer coated, it is possible to make finished plates. Aluminum substrate has some certain strength and toughness in printing, and is well featured by hydrophilicity and abrasion resistance, etc. as well after roughening and oxidization. However, the utilization quantity of aluminum material is very large, its price has kept rising, and its cost occupies over 75% of that of the plates, so it is urgent to acquire a new kind of plate which could keep the quality and reduce the cost meanwhile. Now, PS plate with non-aluminum substrate is also adopted, but it could not replace the PS plate with aluminum substrate since its various performance indexes are not reliable or mature.

### BRIEF SUMMARY OF THE INVENTION

Aiming at the deficiency of the existing techniques, the invention provides a kind of offset PS plate with compound support, which could save aluminum materials and enjoys reliable performance, and also provides a kind of manufacturing process at the same time.

PS plate of this invention includes aluminum substrate, has sensitization imaging layer set up on the front side of its aluminum substrate, and has a membrane of polymer materials covered on the back side of the substrate, which form the structure of compound support.

The thickness of the substrate and membrane is 0.1-0.3 mm and 0.01-0.3 mm respectively. The membrane could adopt such polymer material with great rigidity as POM, PET, PC or PPS., with the membrane pre-coated with heat-melt adhesive as the prior selection.

The manufacturing process of this invention firstly deoils and cleans the aluminum substrate, then conducts electrochemical corrosion and roughening for the surface of the substrate, generates oxidation layer through the oxidization of anode, carries out sealing or hydrophilic treatment for the oxidation layer, and coat sensitization liquid onto this oxidation layer; finally, dries and cuts the plates into finished products. And it is possible to cover a membrane of polymer materials on the back side of the substrate after deoiling and cleaning the substrate.

In fact, it is possible to cover a membrane on the substrate after any step of the abovementioned process, or even after drying and cutting of plates. In case the membrane is compounded before the commencement of electrochemical treatment, it is available to keep the back side of aluminum materials from contacting the chemicals, save electric energy, avoid over electrochemical reaction at the edges of front side, and enhance the performance of finished products. Generally, membrane is usually stuck to and covered on the substrate with the heat melting and stitching method.

The compound support substrate of this invention continues using the advantage of aluminum materials, namely the adsorptive sensitization imaging layer, and sets up membrane layer on the back side. It is possible to use relatively thin aluminum materials to keep relatively high quality, greatly reduce the consumption of aluminum, and decrease the cost. The membrane of polymer materials is featured by strong toughness; after compounding, the substrate enjoys great tensile strength, so the plate is not easy to break during printing; and also, the polymer materials have lower density, which could lighten the weight of finished plates, decrease the requirements on package strength and the transport cost. In addition, polymer membranes have extremely smooth surface, so multiple sheets of PS plates overlapped won't scratch the sensitization layer on the front side of each other, and will require no interleaving paper. What's more, the manufacturing process of PS plate with compound support is basically accordant with the original one, and the compounding of membrane is simple and quick.

The following further illustrates the invention by combining the attached figures and implementation example.

### BRIEF DESCRIPTION OF THE DRAWINGS

FIG. 1 is the schematic diagram of section structure of PS plate;

FIG. 2 is the schematic diagram of the heat melting and stitching state.

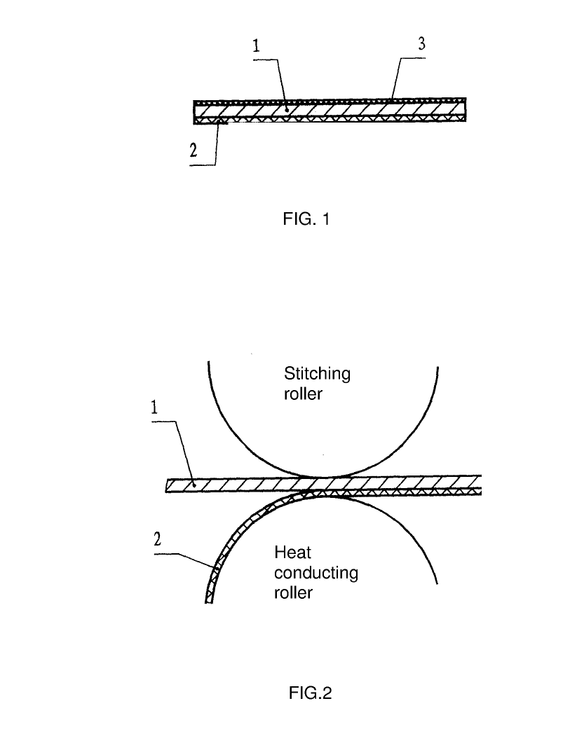

### DETAILED DESCRIPTION OF THE INVENTION

As shown in the figures, the substrate 1 has sensitization imaging layer 3 set up on the front side, and has a membrane 2 of polymer materials covered on the back side, which form the structure of compound support. In manufacturing, the aluminum substrate 1 adopted for PS plate is 0.142 mm in thickness; the membrane 2 adopts PET pre-coated film of 0.075 mm in thickness; and pre-coating binder adopts ethene-ethylene vinyl acetate copolymer (EVA) or polymer resin.

And in manufacturing, firstly, deoil and clean the aluminum substrate 1, send it to between the heat conducting roller and stitching roller of the compound equipment, and cover the membrane 2 to the back side of the substrate 1 by making use of pressure and temperature through heat melting and stitching; then conduct electrochemical corrosion and roughening on the surface of substrate 1, generate oxidation layer through the oxidization of anode on the surface of substrate 1, carry out sealing treatment for the oxidation layer, and coat sensitization liquid onto this oxidation layer; finally, dry and cut the plates into finished products.

Relative to PS plate with full aluminum substrate, the PS plate with compound support obtained has various excellent performances, including weight, fracture resistance, friction safety, and printing adaptability, etc.

In case of manufacturing of CTP plate, the manufacturing process is basically the same, and requires coating image liquid on the substrate 1, and the finished compound support dried and cut enjoy various excellent performances.

I claim:

1. This invention involves with a kind of offset PS plate with compound support, this PS plate includes aluminum substrate and has sensitization imaging layer set up on the front side of its aluminum substrate, it is featured by that the back side of the substrate (1) is covered with a membrane (2) of polymer materials, which form the structure of compound support.

2. According to the claim of Right 1, the offset PS plate with compound support is featured by that the thickness of the substrate (1) and membrane (2) is 0.1-0.3 mm and 0.01-0.3 mm respectively.

3. According to the claim of Right 1, the offset PS plate with compound support is featured by that the polymer material adopted for membrane (2) is POM, PET, PC or PPS.

4. According to the claim of Right 2, the offset PS plate with compound support is featured by that the polymer material adopted for membrane (2) is POM, PET, PC or PPS.

5. According to the claim of Right 1, the manufacturing process of PS plate firstly deoils and cleans the aluminum substrate, then conducts electrochemical corrosion and roughening for the surface of the substrate, generates oxidation layer through the oxidization of anode, carries out sealing or hydrophilic treatment for the oxidation layer, and coats sensitization liquid onto this oxidation layer; finally, dries and cuts the plates into finished products; the process is featured by that it is possible to cover a membrane (2) of polymer materials on the back side of the substrate (1) after deoiling and cleaning the substrate (1).

6. According to the claim of Right 5, the manufacturing process of PS plate is featured by that it is possible to cover a membrane (2) on the substrate (1) after any step of the above mentioned process, or even after drying and cutting of plates.

7. According to the claim of Right 5, the manufacturing process of PS plate is featured by that the membrane (2) is stuck to and covered on the substrate (1) by means of heat melting and stitching.

8. According to the claim of Right 6, the manufacturing process of PS plate is featured by that the membrane (2) is stuck to and covered on the substrate (1) by means of heat melting and stitching.

9. According to the claim of Right 7, the manufacturing process of PS plate is featured by that the binder for heat melting and stitching adopts ethene-ethylene vinyl acetate copolymer or polymer resin.

10. According to the claim of Right 8, the manufacturing process of PS plate is featured by that the binder for heat melting and stitching adopts ethene-ethylene vinyl acetate copolymer or polymer resin.
